(19) United States
(12) Patent Application Publication
(10) Pub. No.: US 2008/0216664 A1
(43) Pub. Date: Sep. 11, 2008

(54) ELECTRONIC TEA THERMOMETER AND TIMER DEVICE

(75) Inventors: Jeffrey David Koon, Lombard, IL (US); Elizabeth Wentland, Chicago, IL (US); Heather Liska, Downers Grove, IL (US); Lisa Dodge, Oak Park, IL (US)

Correspondence Address: BROOKS KUSHMAN P.C., 1000 TOWN CENTER, TWENTY-SECOND FLOOR, SOUTHFIELD, MI, 48075, US

(73) Assignee: TAYLOR PRECISION PRODUCTS, INC., Oak Brook, IL (US)

(21) Appl. No.: 12/043,477

(22) Filed: Mar. 6, 2008

Related U.S. Application Data
(60) Provisional application No. 60/894,033, filed on Mar. 9, 2007.

(51) Int. Cl. A47J 31/00

(52) U.S. Cl. 99/280

(57) ABSTRACT

A method of steeping tea including receiving a tea type; receiving tea data records, each including tea type, steeping time and steeping temperature; matching the tea type to one of the number of tea data records to obtain a corresponding steeping time and a corresponding steeping temperature; receiving successive sensed temperature readings of the steeping liquid; comparing the successive sensed temperature readings with the corresponding steeping temperature; once one of the successive sensed temperature readings reaches the corresponding steeping temperature, providing a first alert that the steeping temperature has been reached; after the first alerting step, receiving a dry tea input indicating that a dry tea has been added to the brewing liquid; activating a countdown of the corresponding steeping time after receiving the dry tea input; and once the corresponding steeping time elapses according to the countdown, providing a second alert indicating that the steeping time has elapsed.

### CROSS-REFERENCE TO RELATED APPLICATION

This application claims the benefit of U.S. provisional application 60/894,033 filed Mar. 9, 2007, which is incorporated by reference herein.

### BACKGROUND

1. Technical Field

One or more embodiments of the present invention generally relates to an electronic tea thermometer and timer device.

2. Background Art

Tea drinking is a time honored tradition in many countries throughout the world. Tea is typically prepared through a brewing process. According to one brewing process, a predetermined volume of water is heated to an appropriate temperature to obtain heated water, which is then mixed with a predetermined amount of dry tea and steeped for a predetermined time duration to obtain brewed tea. The recommended steeping temperature and steeping time can vary widely based on the type of tea used in the brewing process.

The quality of the resulting brewed tea may be sacrificed if the recommended steeping temperature and time are not followed. Even for an avid tea drinker, keeping track of the recommended values for each tea type is an often cumbersome task. Many casual tea drinkers default to “average” steeping temperatures and steeping times, which may increase the variability of the brewing process and may decrease the quality of the resulting brewed tea.

### SUMMARY

According to one aspect of the present invention, an electronic tea thermometer and timer device for simplifying and streamlining the brewing process is provided. In another aspect of the present invention, the electronic tea thermometer and timer device can be utilized in combination with a heating element to heat water and steep tea in a single vessel. In yet another aspect of the present invention, an electronic tea thermometer and timer device is provided which integrates a temperature sensing feature and a timer feature within a single, integral unit.

In one embodiment, a method of steeping tea is disclosed. The method of steeping tea includes receiving a tea type; receiving tea data records, each including tea type, steeping time and steeping temperature; matching the tea type to one of the number of tea data records to obtain a corresponding steeping time and a corresponding steeping temperature; receiving successive sensed temperature readings of the steeping liquid; comparing the successive sensed temperature readings with the corresponding steeping temperature; once one of the successive sensed temperature readings reaches the corresponding steeping temperature, providing a first alert that the steeping temperature has been reached; after the first alerting step, receiving a dry tea input indicating that a dry tea has been added to the brewing liquid; activating a countdown of the corresponding steeping time after receiving the dry tea input; and once the corresponding steeping time elapses according to the countdown, providing a second alert indicating that the steeping time has elapsed.

The above embodiments, and other embodiments, objects, features, and advantages of the multiple embodiments of the present invention are readily apparent from the following detailed description of the embodiments when taken in conjunction with the accompanying drawings.

### BRIEF DESCRIPTION OF THE DRAWINGS

FIG. 1 is a system diagram of an electronic tea thermometer and timer unit according to one embodiment of the present invention;

FIG. 2 is a perspective view of an electronic tea thermometer and timer unit according to one embodiment of the present invention;

FIG. 3 is a plan view of the electronic tea thermometer and timer unit shown in FIG. 2;

FIG. 4 is a side view of the electronic tea thermometer and timer unit shown in FIG. 2; and

FIG. 5 is a flowchart illustrating the method steps of one embodiment of the present invention.

### DETAILED DESCRIPTION OF EMBODIMENTS

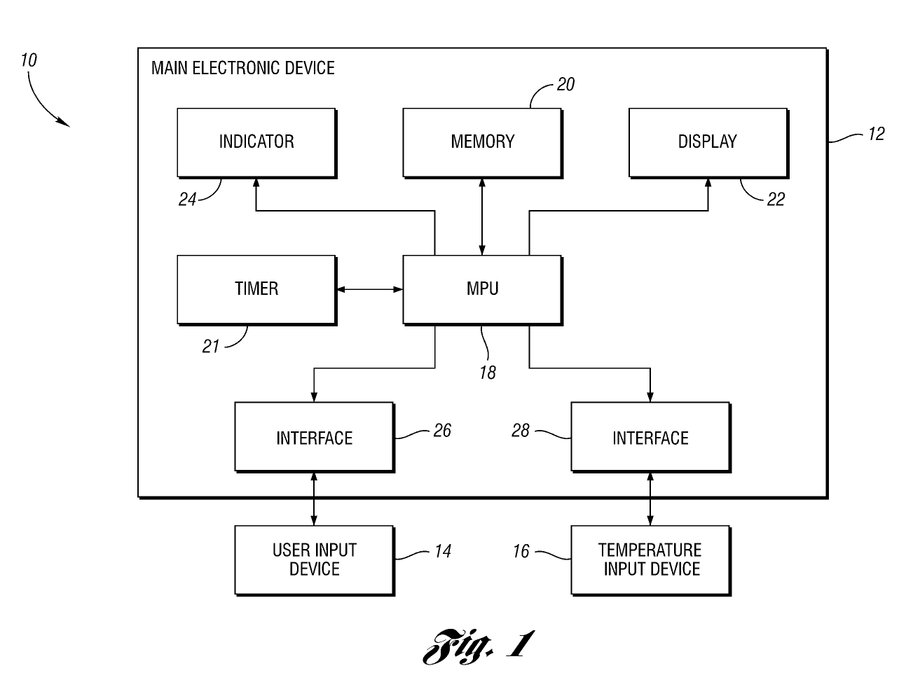

FIG. 1 depicts an electronic tea thermometer and timer unit 10 according to one embodiment of the present invention. The unit 10 generally includes a main electronic device 12, a user input device 14 and a temperature input device 16. The main electronic device 12 generally includes a micro processing unit (MPU) 18, a memory 20, timer module 21 (e.g., clock timer), a display 22, an indicator 24, and interfaces 26 and 28.

In at least one embodiment, the user input device 14 includes one or more depressable buttons or keys that can be actuated by a user. In at least one embodiment, the temperature input device 16 is an elongated metal temperature probe for sensing the temperature of water that at least partially surrounds the probe. In at least one embodiment, the temperature probe is capable of sensing temperatures in the range of −9 to 150 C. (16 to 320 F.).

The MPU 18 can be adapted to carry out one or more steps of a tea brewing process. In at least one embodiment, the MPU 18 is adapted to execute machine instructions for carrying out one or more steps of the tea brewing process and memory 20 is adapted to store machine instructions that are to be executed by the MPU 18. The memory 18 can be non-volatile memory, for example, read-only memory or flash memory, and can be configured to store data relating to the tea brewing process, e.g., steeping temperatures and steeping times for a number of tea types. The memory 18 can also be configured to store software and/or firmware relating to the tea brewing process. Timer module 21 is electronically connected to MPU 18. In at least one embodiment, a timing algorithm can be stored in memory 20 and executed by MPU 18, which electronically communicates with the timer module 21 to keep the elapsed and/or remaining time during a countdown period. In at least one embodiment, the timing algorithm can be set for time periods in the range of 10 seconds to 99 minutes and 59 seconds.

In one embodiment, the tea brewing data is stored in the memory 20 before the memory 20 and the other components of the main electronic device 12 are assembled. In another embodiment, the tea brewing data is stored on the memory 20 after assembly. Table 1 lists the tea brewing data according to one embodiment of the present invention.

TABLE 1

| Tea Type | Steeping Temperature | Steeping Time |
|---|---|---|
| White | 155 | 120 seconds |
| Green | 170 | 150 seconds |
| Oolong | 195 | 240 seconds |
| Black | 212 | 300 seconds |
| Herbal | 205 | 360 seconds |
| Puerh | 190 | 480 seconds |
| Darjeeling | 212 | 120 seconds |

Table 2 lists the tea brewing data according to another embodiment of the present invention.

TABLE 2

| Tea Type | Steeping Temperature | Steeping Time |
|---|---|---|
| White | 155 | 90 seconds |
| Green | 170 | 150 seconds |
| Oolong | 190 | 240 seconds |
| Black | 205 | 240 seconds |
| Herbal | 205 | 360 seconds |
| Puerh | 205 | 270 seconds |
| Darjeeling | 205 | 120 seconds |

The display 22 is electrically connected to the MPU 18, which can format data for display on display 22. The display 22 can be configured to display information relating to the tea brewing process, e.g., sensed water temperature and timer values. Additional non-limiting information can include tea types, steeping temperatures, and steeping times. A non-limiting example of display 22 is a liquid crystal display (LCD).

The indicator 24 is electrically connected to the MPU 18, which can transmit signals to indicator 24 to activate indicator 24. Non-limiting examples of indicator 24 include an audio indicator, e.g., buzzer, and/or a visual indicator, e.g. light emitting diode (LED) capable of emitting a colored light, e.g., green light.

The interfaces 26 and 28 are electrically connected to the MPU 18. The interfaces 26 and/or 28 convert non-electrical input received from the user input device 14 and/or the temperature input device 16 into electrical output signals that can be transmitted to MPU 18 for further processing.

In at least one embodiment, the temperature input device 16 and timer module 21 are electronically coupled to the MPU 18 to provide an integrated unit for brewing tea, including, temperature measurements and/or timing of steeping times.

The “term electronically coupled” is not limited to direct electrical connections and includes indirect electrical connections.

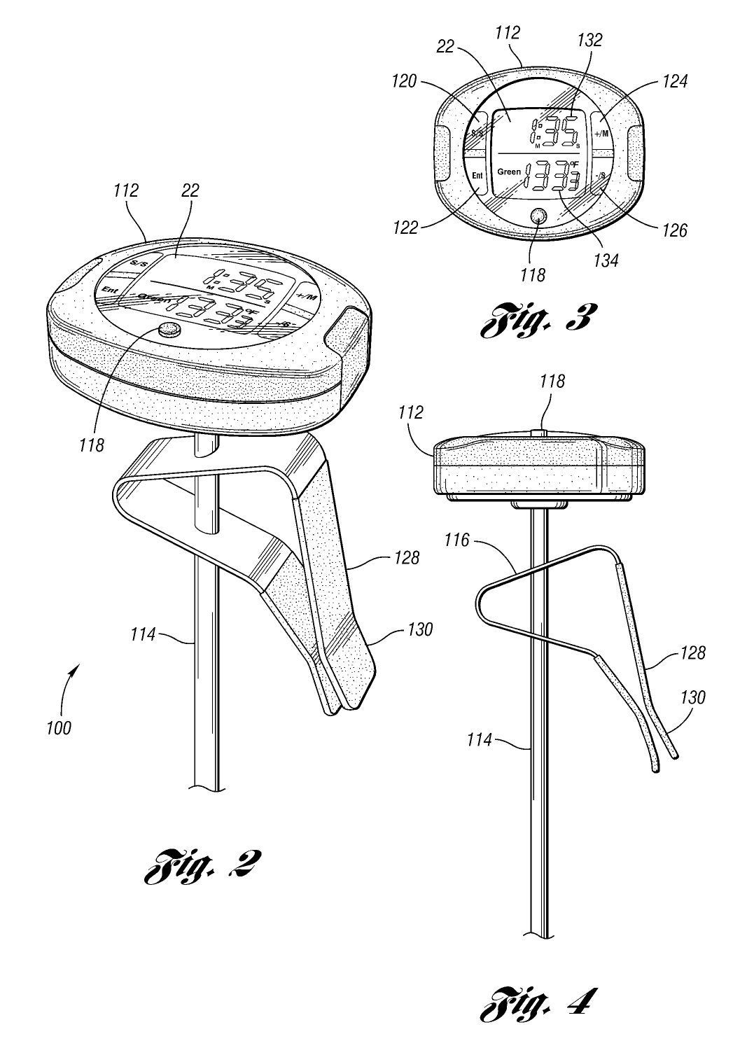

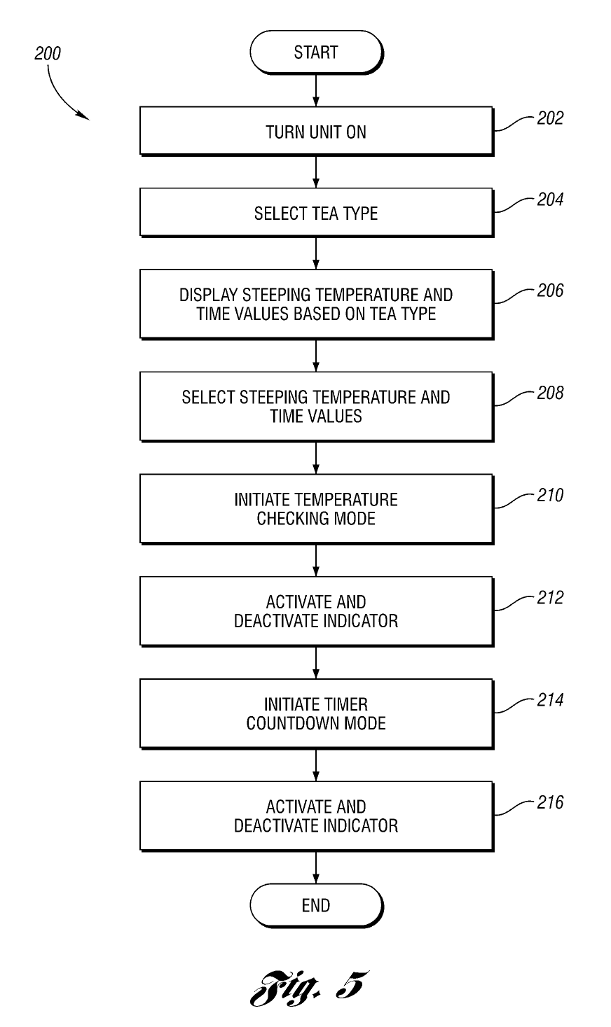

FIGS. 2, 3 and 4 depict an electronic tea thermometer and timer device 100 according to one embodiment of the present invention. The device 100 generally includes a housing 112, a temperature probe 114, and a clip 116.

The housing 112 includes components of the main electronic device 12 and the user input device 14 of FIG. 1. The housing 112 forms an internal cavity for disposing MPU 18, memory 20, timer module 21, display 22, indicator 24, and interfaces 26 and 28. The indicator 24 includes a visual indicator 118 and an audible indicator. The visual indicator 118 is an LED capable of displaying sustained and/or intermittent (e.g. blinking) light, e.g., green light. The audible indicator can be a speaker capable of generating a buzzing sound.

The upper surface of the housing 112 includes first, second, third and fourth buttons 120, 122, 124 and 126, which serve as the user input device 14. The buttons 120, 122, 124 and 126 are situated around the periphery of the upper surface, although the placement of the buttons on the surface of the housing 112 can be modified depending on the implementation of the present invention. Further, the number of input buttons can also be modified without departing from the spirit and scope of the present invention. In at least one embodiment, the first, second, third and fourth buttons 120, 122, 124 and 126 are referred to as the “Start/Stop,” “Enter,” “+/Min,” and “−/Sec” buttons, respectively. The main electronic device 10 can be turned on by pressing any of the buttons 120, 122, 124 or 126. In at least one embodiment, the main electronic device 12 has an auto power off feature in which the device 12 shuts down after 10 minutes of inactivity. For example, the beginning of inactivity may be the point at which the tea brewing cycle has been completed, i.e., after the indicator signals the end of the steeping period. In at least one embodiment, if the user input device 14 is actuated, then the period of inactivity restarts. In at least one embodiment, the temperature units can be changed between C and F by pressing and holding the “Start/Stop” button for 3 seconds.

The upper surface of housing 112 includes a substantially rectangular opening or transparent material to accommodate viewing of information displayed on display 22. The upper surface of housing 112 also includes a substantially circular opening or transparent material to accommodate viewing of the LED indicator 118.

In at least one embodiment, the temperature probe 114 is connected to the housing 112 and extends substantially orthogonally from the lower surface of housing 112. The temperature probe 114 can be made of a conductive metal or metal alloy. The temperature probe 114 is connected to the interface 28 for converting the thermal data received from the probe 114 into an electronic output signal.

In at least one embodiment, the clip 116 includes a gripping portion 128 for engaging the side of a tea brewing vessel, for example, a tea kettle or pot. The gripping portion 128 can include a coating 130 for enhancing the gripping ability of the clip. The coating 130 can be made of a polymeric material, for example, a soft rubber or silicone.

The display 22 can include an upper display portion 132 and a lower display portion 134. In at least one embodiment, the upper display portion 132 can display the time remaining or elapsed during a timing period. The lower display portion 136 can display the current temperature of the water during the water heating step and/or steeping step.

FIG. 5 illustrates a flowchart 200 including the method steps for brewing tea with the electronic tea thermometer and timer unit 10 according to one embodiment of the present invention. In block 202, the unit 10 is turned on by pressing any of the input buttons 120, 122, 124 or 126.

In block 204, the tea type is selected. In at least one embodiment, the tea type is selected from a number of pre-selected tea types, e.g., the tea types identified in Table 1. The display 22 can be configured to display the tea type by name or abbreviation. The user can cycle through the tea types by utilizing the “+/Min” or “−/Sec” buttons. The user can select the presently displayed tea type by pressing the “Enter” button. The selected tea type is transmitted to the MPU 18, which retrieves the steeping temperature and steeping time information from a table stored in memory 20. The selected tea type can also be stored on memory 20.

In block 206, the retrieved steeping temperature and time values are displayed on display 28. In at least one embodiment, the steeping temperature is displayed in the lower display portion 134 and the steeping time is displayed in the upper display portion 132.

In block 208, the steeping temperature and time values are set by the user. In at least one embodiment, the steeping temperature value is initially displayed in a blinking mode in the lower display portion 134. At this point, the user is presented with the opportunity to adjust the steeping temperature. This situation may arise if the tea type to be brewed is not stored in memory 20, and the user, instead, selects a similar tea type from the database. If the user decides to adjust the steeping temperature, the user selects the “+/Min” button to increase the steeping temperature and/or “−/Sec” button to decrease the steeping temperature. Once the user is satisfied with the steeping temperature (either initially or through adjustment), then the user presses the “Enter” button to set the steeping temperature. Subsequently, the steeping temperature value is displayed in a blinking mode in the upper display portion 132. At this point, the user is presented with the opportunity to adjust the steeping time. If the user decides to adjust the steeping time, the user selects the “+/Min” button to increase the steeping time and/or “−/Sec” button to decrease the steeping time. Once the user is satisfied with the steeping time (either initially or through adjustment), then the user presses the “Enter” button to set the steeping time.

After the steeping temperature and time is set, the user presses the “Enter” button to initiate a temperature checking mode, as depicted in block 210. In one embodiment, a brewing vessel, e.g., a tea kettle, is filled with the appropriate volume of water and placed on a cooking element, e.g. stove top. At this point, the user can initiate the temperature checking mode and place at least a portion of the temperature probe 114 into the water contained within the vessel. The user then turns on the cooking element to start the process of heating the water. During the temperature checking mode, the MPU 18 either continuously or intermittently received the temperature of the water as measured by the temperature probe 114. The received temperatures can be displayed on display 22 to give the user feedback. During the temperature checking mode, the MPU 18 compares each received temperature to the set steeping temperature.

Once the received temperature reaches the selected steeping temperature, the indicator 24 is automatically activated (block 212). In one embodiment, the steeping liquid, e.g., water, is brought to a boil before insertion of the temperature probe 114. At this point, the heat applied to the steeping liquid is reduced, and then the temperature probe is inserted into the steeping liquid. In this embodiment, the temperature of the steeping liquid is lowered to reach the selected steeping temperature. In another embodiment, the temperature probe 114 is inserted into the steeping liquid before heat is applied. In this embodiment, the temperature of the steeping liquid is raised to reach the selected steeping temperature.

In at least one embodiment, step 212 includes activating the audible indicator and the visual indicator. The activation of indicator 24 prompts the user to add the dry tea to the steeping water. When the user adds the dry tea to the steeping water, the user presses the “Start/stop” button to deactivate the indicator 24 and to automatically initiate timer countdown mode (block 214). The countdown begins from the selected steeping time. During the timer countdown mode, the MPU 18 executes instructions for keeping track of the elapsed time period. Further, the remaining or elapsed time can be displayed on display 22 to give the user feedback. Once the selected steeping time completely elapses, the indicator 24 is automatically activated (block 216). In at least one embodiment, step 216 includes activating the audible indicator and the visual indicator. The activation of indicator 24 prompts the user to deactivate the indicator 24 and that the tea brewing process has concluded. At this point, the user can pour the brewed tea product from the brewing vessel to a tea cup or other personal drinking container, e.g., tea cup, for drinking enjoyment.

Advantageously, the main electronic device 12 of unit 10 presents an integrated solution for heating water and steeping tea with minimal user intervention. Once the user selects a steeping temperature and time, the user has to press an input button only twice (i.e., once after conclusion of the temperature checking mode and once after conclusion of the countdown mode) during the brewing process. Moreover, the storage of tea data records, each including a tea type, steeping temperature and steeping time, in the database 20, allows the user easy access to tea brewing information that allows for consistent brewing of a wide variety of tea types. The combination of the temperature measuring feature and timing feature with a single, integral unit facilitates a user friendly and repeatable process and system for brewing tea of consistent quality.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, the device, system and techniques of one or more embodiments of the present invention can be utilized to brew coffee or hot chocolate.

What is claimed is:

1. An electronic tea thermometer and timer unit for steeping a tea in a steeping liquid, the unit comprising:
a main electronic device including:
a microprocessing unit (“MPU”) for executing machine instructions, a memory for storing machine instructions that are to be executed by the MPU and a number of tea data records, each tea data record including a tea type, a steeping time corresponding to the tea type and a steeping temperature corresponding to the tea type, and an indicator for providing an indication;
a temperature input device for sensing the temperature of a steeping liquid at least partially surrounding the temperature input device and operatively coupled to the main electronic device; and
a user input device for receiving input relating to tea steeping and operatively coupled to the main electronic device,
the machine instruction when executed by the MPU implementing the following functions:
receiving a tea type through the user input device;
matching the tea type to one of the number of tea data records to obtain a corresponding steeping time and a corresponding steeping temperature;
receiving a successive number of sensed temperature readings of the steeping liquid at least partially surrounding the temperature input device;
comparing the successive number of sensed temperature readings with the corresponding steeping temperature;
once one of the successive number of sensed temperature readings reaches the corresponding steeping temperature, activating the indicator with a first indication;
after the first activating step, receiving a dry tea input indicating that a dry tea has been added to the steeping liquid;
activating a countdown of the corresponding steeping time after receiving the dry tea input; and
once the corresponding steeping time elapses according to the countdown, activating the indicator with a second indication.

2. The electronic tea thermometer and timer unit of claim 1, the unit further comprising a display device for displaying the successive number of sensed temperature readings and the countdown of the corresponding steeping time.

3. The electronic tea thermometer and timer unit of claim 2, wherein the machine instructions when executed by the MPU further implement the following functions:
formatting the corresponding steeping time and the corresponding steeping temperature for display on the display device;
receiving a steeping time adjustment or a steeping temperature adjustment; and
adjusting the corresponding steeping time or the corresponding steeping temperature based on the steeping time adjustment or the steeping temperature adjustment.

4. The electronic tea thermometer and timer unit of claim 1, the unit further comprising a timer module for timing the countdown of the corresponding steeping time.

5. The electronic tea thermometer and timer unit of claim 1, wherein the first and second indications are each an audio or visual indication.

6. The electronic tea thermometer and timer unit of claim 1, wherein the number of tea records includes three tea records selected from the group consisting of the following tea records: white tea, green tea, oolong tea, black tea, herbal tea, puerh tea and darjeeling tea.

7. The electronic tea thermometer and timer unit of claim 1, wherein the temperature input device is an elongated metal temperature probe.

8. The electronic tea thermometer and timer unit of claim 1, wherein the user input device is a number of depressable buttons.

9. The electronic tea thermometer and timer unit of claim 1, wherein the machine instructions when executed by the CPU further implement the following functions:
during the first receiving step, formatting each of the successive temperature readings for display on the display device so as to provide feedback to the individual steeping the tea.

10. The electronic tea thermometer and timer unit of claim 1, wherein the machine instructions when executed by the CPU further implement the following functions:
after the second activating step, formatting either the elapsed time or remaining time in the countdown for display on the display device.

11. An electronic tea thermometer and timer unit for steeping a tea in a steeping liquid, the unit comprising:
a housing defining an internal cavity;
a main electronic device disposed within the internal cavity and including:
a microprocessing unit (“MPU”) for executing machine instructions, a memory for storing machine instructions that are to be executed by the MPU and a number of tea data records, each tea data record including a tea type, a steeping time corresponding to the tea type and a steeping temperature corresponding to the tea type, and an indicator for providing an indication;
a temperature input device for sensing the temperature of a steeping liquid at least partially surrounding the temperature input device and operatively coupled to the main electronic device; and
a user input device for receiving input relating to tea steeping and operatively coupled to the main electronic device,
the machine instruction when executed by the MPU implementing the following functions:
receiving a tea type through the user input device;
matching the tea type to one of the number of tea data records to obtain a corresponding steeping time and a corresponding steeping temperature;
receiving a successive number of sensed temperature readings of the brewing liquid at least partially surrounding the temperature input device;
comparing the successive number of sensed temperature readings with the corresponding steeping temperature;
once one of the successive number of sensed temperature readings reaches the corresponding steeping temperature, activating the indicator with a first indication;
after the first activating step, receiving a dry tea input indicating that a dry tea has been added to the steeping liquid;
activating a countdown of the corresponding steeping time after receiving the dry tea input; and
once the corresponding steeping time elapses according to the countdown, activating the indicator with a second indication.

12. A method of brewing tea for steeping a tea in a steeping liquid, the method comprising:
receiving a tea type through a user input device;
receiving a number of tea data records, each tea data record including a tea type, a steeping time corresponding to the tea type and a steeping temperature corresponding to the tea type;
matching the tea type to one of the number of tea data records to obtain a corresponding steeping time and a corresponding steeping temperature;
receiving a successive number of sensed temperature readings of the steeping liquid;
comparing the successive number of sensed temperature readings with the corresponding steeping temperature;
once one of the successive number of sensed temperature readings reaches the corresponding steeping temperature, providing a first alert that the steeping temperature has been reached;
after the first providing step, receiving a dry tea input indicating that a dry tea has been added to the steeping liquid;
activating a countdown of the corresponding steeping time after receiving the dry tea input; and
once the corresponding steeping time elapses according to the countdown, providing a second alert indicating that the steeping time has elapsed.

13. The method of claim 12, further comprising storing the number of tea records in a database.

14. The method of claim 12, further comprising:
receiving a steeping time adjustment or a steeping temperature adjustment; and
adjusting the corresponding steeping time or the corresponding steeping temperature based on the steeping time adjustment or the steeping temperature adjustment.

15. The method of claim 12, further comprising displaying the successive number of sensed temperature readings and the countdown of the corresponding steeping time.

16. The method of claim 12 wherein the first and second providing steps are carried out using an indicator.

17. The method of claim 13, further comprising sensing the successive temperature readings with a temperature input device at least partially surrounded by the steeping liquid, and the temperature input device being electronically coupled to the database.

18. The method of claim 17, wherein step 4-9 of claim 12 are carried out while the temperature input device is continuously at least partially surrounded by the brewing liquid.

19. The method of claim 12, wherein the number of tea records includes three tea records selected from the group consisting of the following tea records: white tea, green tea, oolong tea, black tea, herbal tea, puerh tea and darjeeling tea.

20. The method of claim 12, further comprising during the first receiving step, displaying each of the successive temperature readings so as to provide feedback to the individual brewing the tea.
